(19) United States
(12) Patent Application Publication
(10) Pub. No.: US 2014/0078386 A1
(43) Pub. Date: Mar. 20, 2014

(54) Lens Module

(71) Applicants: Asia Optical International Ltd., Tortola (GB); Sintai Optical (Shenzhen) Co., Ltd., Shenzhen City (CN)

(72) Inventor: Chien-Lung Chang, Taichung (TW)

(21) Appl. No.: 13/917,793

(22) Filed: Jun. 14, 2013

(30) Foreign Application Priority Data
Sep. 18, 2012 (TW) 101134080

(51) Int. Cl. H04N 5/225

(52) U.S. Cl. CPC H04N 5/2253; H04N 5/2254
USPC 348/374

(57) ABSTRACT

A lens module includes a lens set, an image sensor, a circuit board and a case. The lens set is configured to receive an optical image. The image sensor is configured to convert the optical image into an electrical signal. The circuit board includes a thermally conductive metal portion contacting the image sensor. The case is configured to accommodate the lens set, the image sensor and the circuit board and to contact the thermally conductive metal portion of the circuit board.

### BACKGROUND OF THE INVENTION

1. Field of the Invention

The invention relates to a lens module, in particular relates to a lens module with good thermal conductivity.

2. Description of the Related Art

FIG. 1 is a cross-sectional view of a conventional cell-phone lens module 10. The conventional cell-phone lens module 10 includes a lens set 11, an image sensor 12, a circuit board 13, a reinforced plate 14, a protective cover 15 and a frame 16.

The lens set 11 supported by the frame 16 is configured to receive an external optical image and to forming an image on the image sensor 12. The image sensor 12 is configured to convert the received optical image into an electrical signal, and then the electrical signal is externally transmitted via the circuit board 13 for the subsequent image processing.

The reinforced plate 14 disposed below the circuit board 13 is configured to increase the entire mechanical strength. The protective cover 15 is configured to protectively cover the lens set 11, the frame 16 and the image sensor 12.

When the conventional cell-phone lens module 10 is operated, heat generated from the image sensor 12 is majorly dissipated by way of radiation. However, this radiation method cannot afford to efficiently expel heat generated from the conventional cell-phone lens module 10. The performance of the conventional cell-phone lens module 10 will be seriously infected if head dissipation thereof is poor.

### BRIEF SUMMARY OF THE INVENTION

In order to address the shortcomings discussed, the invention provides a lens module including a lens set, an image sensor, a circuit board and a case. The lens set is configured to receive an optical image. The image sensor is configured to convert the optical image into an electrical signal. The circuit board includes a thermally conductive metal portion contacting the image sensor. The case is configured to accommodate the lens set, the image sensor and the circuit board and to contact the thermally conductive metal portion of the circuit board.

According to the invention, the case includes a reinforced plate configured to support the circuit board, and the thermally conductive metal portion of the circuit board contacts the reinforced plate of the case.

According to the invention, the reinforced plate is made of aluminum.

According to the invention, the case includes a protective cover configured to cover the lens set and the image sensor and to connect to the circuit board.

According to the invention, the circuit board further includes a solder joint and a metal wiring extended to the solder joint via the thermally conductive metal portion, and the protective cover of the case is connected to the solder joint of the circuit board.

According to the invention, the protective cover of the case is made of aluminum.

According to the invention, the circuit board further includes a solder joint, and the case includes a reinforced plate and a protective cover electrically connected to the reinforced plate via the solder joint of the circuit board.

According to the invention, the thermally conductive metal portion of the circuit board is made of copper.

According to the invention, the lens module further includes a frame configured to support the lens set.

According to the invention, the image sensor is a charge coupled element or a complementary metal oxide semiconductor image sensing element.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a cross-sectional view of a conventional cell-phone lens module;

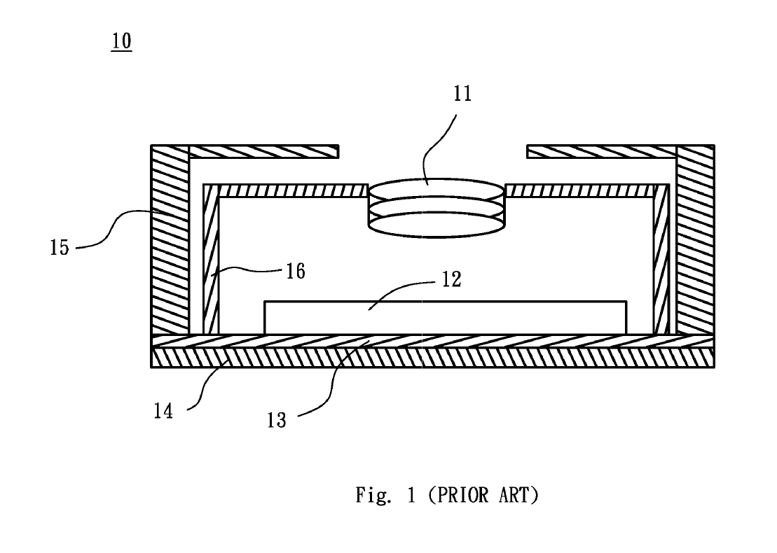

FIG. 2 is a cross-sectional view of a lens module of the invention; and

FIG. 3 is a top view of a circuit board of the invention.

### DETAILED DESCRIPTION OF THE INVENTION

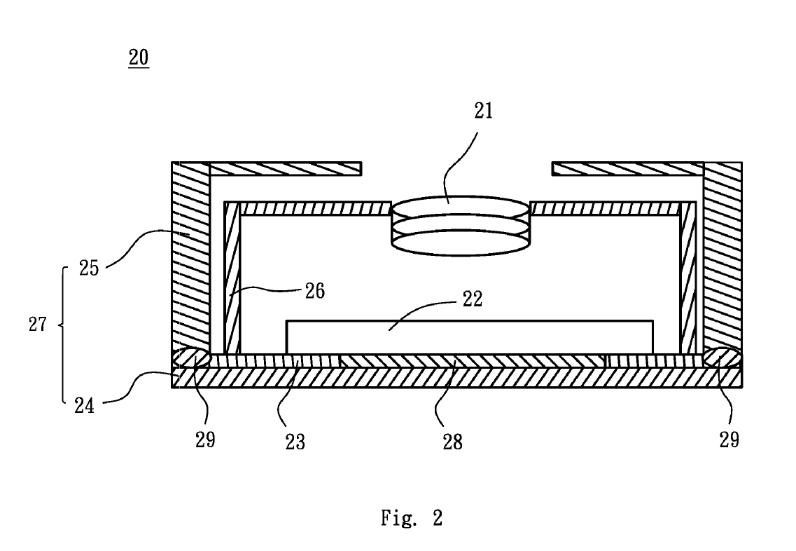

FIG. 2 is a cross-sectional view of a lens module 20 of the invention. In FIG. 2, the lens module 20 includes a lens set 21, an image sensor 22, a circuit board 23, a frame 26 and a case 27.

The lens set 21 supported by the frame 26 is configured to receive an external optical image and to form an image on the image sensor 22. The image sensor 22 is configured to convert the received optical image into an electrical signal, and then the electrical signal is externally transmitted via the circuit board 23 for the subsequent image processing. The image sensor 22 can be a charge-coupled device (CCD), a complementary metal oxide semiconductor (CMOS) image sensing element, and so on.

The case 27 includes a reinforced plate 24 and a protective cover 25, in which the reinforced plate 24 is configured to support the circuit board 23 and capable of increasing the entire mechanical strength, and the protective cover 25 is configured to protectively cover the lens set 21, the frame 26 and the image sensor 22 and to connect to the circuit board 23. The reinforced plate 24 and the protective cover 25 of the case 27 are made of, for example, aluminum and electrically connected to each other via the solder joint 29 of the circuit board 23, thus forming an electromagnetic interference (EMI) preventing structure to prevent the image sensor 22 from external electromagnetic waves.

The circuit board 23 includes a thermally conductive metal portion 28 and a through hole. The through hole is located under the image sensor 22, with the thermally conductive metal portion 28 formed therein. The thermally conductive metal portion 28 contacts the image sensor 22 and the reinforced plate 24 of the case 27, so that heat generated from the image sensor 22 can be transferred to the reinforced plate 24 of the case 27 via the thermally conductive metal portion 28 of the circuit board 23. The thermally conductive metal portion 28 of the circuit board 23 is made of, for example, copper. Due to the reinforced plate 24 of the case 27 that is made of good thermal conductive material and provided with large-sized heat dissipation area, the heat dissipation effect of the lens module 20 of the invention can be efficiently promoted.

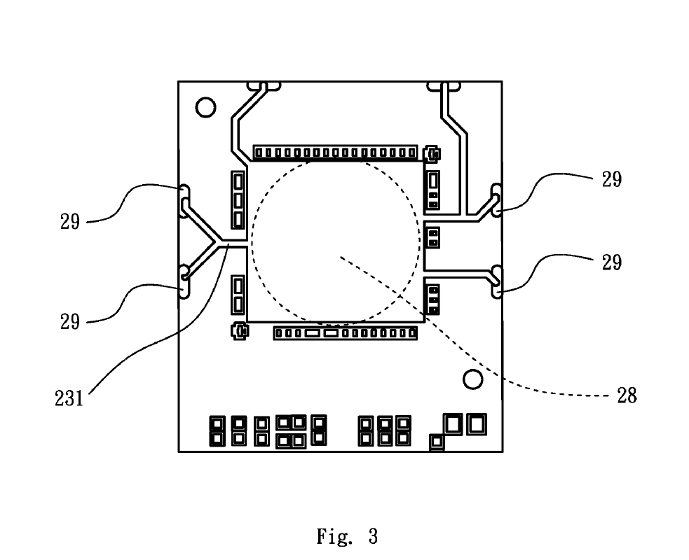

FIG. 3 is a top view of the circuit board 23 of the invention. In FIG. 3, the circuit board 23 further includes a metal wiring 231 extending from the thermally conductive metal portion 28 to the solder joint 29, so that heat from the thermally conductive metal portion 28 can be transferred to the protective cover 25 through the solder joint 29 for heat dissipation. Note that the metal wiring 231 of the circuit board 23 does not be configured to transmit any electrical signals, i.e., the metal wiring 231 of the circuit board 23 simply is served as a thermal conductive path for enhancing the heat dissipation effect.

In conclusion, in the lens module 20 of the invention, the thermally conductive metal portion 28 of the circuit board 23 contacts the image sensor 22 and the reinforced plate 24 of the case 27 that are located at different sides, heat generated from the image sensor 22 is transferred to the reinforced plate 24 of the case 27, and heat from the thermally conductive metal portion 28 can be transferred to the protective cover 25 through the metal wiring 231 of the circuit board 23. Accordingly, the reinforced plate 24 of the case 27 and the protective cover 25, which are formed with large-sized heat dissipation area and good thermal conductivity, can provide a good heat dissipation effect.

While this invention has been described in connection with what is presently considered to be the most practical and preferred embodiment, it is to be understood that the invention is not limited to the disclosed embodiments, but, on the contrary, is intended to cover various modifications and equivalent arrangements included within the spirit and scope of the appended claims.

What is claimed is:

1. A lens module, comprising:
a lens set configured to receive an optical image;
an image sensor configured to convert the optical image into an electrical signal;
a circuit board comprising a thermally conductive metal portion contacting the image sensor; and
a case configured to accommodate the lens set, the image sensor and the circuit board and to contact the thermally conductive metal portion of the circuit board.

2. The lens module as claimed in claim 1, wherein the case comprises a reinforced plate configured to support the circuit board, and the thermally conductive metal portion of the circuit board contacts the reinforced plate of the case.

3. The lens module as claimed in claim 2, wherein the reinforced plate is made of aluminum.

4. The lens module as claimed in claim 1, wherein the case comprises a protective cover configured to cover the lens set and the image sensor and to connect to the circuit board.

5. The lens module as claimed in claim 4, wherein the circuit board further comprises a solder joint and a metal wiring, the protective cover of the case is connected to the solder joint of the circuit board, and the metal wiring extends from the thermally conductive metal portion to the solder joint.

6. The lens module as claimed in claim 4, wherein the protective cover of the case is made of aluminum.

7. The lens module as claimed in claim 1, wherein the circuit board further comprises a solder joint, and the case comprises a reinforced plate and a protective cover electrically connected to the reinforced plate via the solder joint of the circuit board.

8. The lens module as claimed in claim 1, wherein the thermally conductive metal portion of the circuit board is made of copper.

9. The lens module as claimed in claim 1 further comprising a frame configured to support the lens set.

10. The lens module as claimed in claim 1, wherein the image sensor comprises a charge coupled device or a complementary metal oxide semiconductor image sending element.
